(19) United States
(12) Patent Application Publication
(10) Pub. No.: US 2009/0054145 A1
(43) Pub. Date: Feb. 26, 2009

(54) Three-dimensional wireless game controller

(75) Inventors: Cheng-Yun Yang, Taipei County (TW); Chun-Chin Lin, Taipei County (TW)

Correspondence Address: BACON & THOMAS, PLLC, 625 SLATERS LANE, FOURTH FLOOR, ALEXANDRIA, VA, 22314-1176, US

(73) Assignee: TAI-SOL ELECTRONICS CO., LTD., TAIPEI CITY (TW)

(21) Appl. No.: 11/987,822

(22) Filed: Dec. 5, 2007

(30) Foreign Application Priority Data
Aug. 20, 2007 (TW) 96130776

(51) Int. Cl. A63F 13/02

(52) U.S. Cl. 463/37

(57) ABSTRACT

A 3-D wireless game controller includes a housing having an upper surface, a lower surface, and a grip for holding by the user's hand; a push control element mounted to the upper surface of the housing; a rotation control element rotatably mounted to the lower surface of the housing and located corresponding to the user's forefinger pad while the user holds the grip; a gravity sensor mounted to the housing; a power unit mounted in the housing; and a wireless communication module electrically connected with the push control element, the rotation control element, and the gravity sensor. In light of this, the 3-D wireless game controller allows the user's finger pad to roll the rotation control element for additional control functions.

### BACKGROUND OF THE INVENTION

1. Field of the Invention

The present invention relates generally to game controllers, and more particularly, to a three-dimensional (3-D) wireless game controller.

2. Description of the Related Art

A conventional game controller for a game machine, such as the gamepad for Sony Play Station II, includes a directional pad (D-pad). A user can control the game by pushing the D-pad. Such conventional game controller is usually connected to the game machine by wire or wirelessly via radio frequency (RF) or Bluetooth interface.

Recently, Nintendo Company developed a new game machine, Wii, for which the game controller is sensitive to the motion of the user's hand. The user can wave the game controller to control the game. U.S. Pat. Pub. No. 2007/0066394 filed by Nintendo Company disclosed such game controller, being characterized in the thumb button and the forefinger button located on and beneath the game controller respectively. However, this game controller must provide an additional space for receiving the user's forefinger and it allows the user's forefinger pad to push the finger button only without any other function. Therefore, there is still some space for improvement of the game controller for Wii.

### SUMMARY OF THE INVENTION

The primary objective of the present invention is to provide a 3-D wireless game controller, which does not have to provide an additional space for receiving the user's forefinger and allows the user's forefinger to do an additional control function.

The foregoing objective of the present invention is attained by the 3-D wireless game controller composed of a housing, a push control element, a rotation control element, a gravity sensor, a power element, and a wireless communication module. The housing includes a grip for holding by the user's hand, having an upper surface and a lower surface. The push control element is mounted to the upper surface of the housing and located corresponding to the user's thumb pad while the user holds the grip. The rotation control element is rotatably mounted to the lower surface of the housing and located corresponding to the user's forefinger pad while the user holds the grip. The gravity sensor is mounted to the housing for detecting motions of the hosing and converting them into electronic signals. The power unit is mounted in the housing for supplying power. The wireless communication module is electrically connected with the push control element, the rotation control element, and the gravity sensor for outbound wireless transmission of electronic signals generated from the push control element, the rotation control element, and the gravity sensor. In light of this, the present invention allows the user's finger to roll the rotation control element for additional control functions.

### BRIEF DESCRIPTION OF THE DRAWINGS

FIG. 1 is a side view of a preferred embodiment of the present invention.

FIG. 2 is a top view of the preferred embodiment of the present invention.

FIG. 3 is a perspective view of the preferred embodiment of the present invention.

FIG. 4 is an exploded view of a part of the preferred embodiment of the present invention.

FIG. 5 is a side view of the preferred embodiment of the present invention, illustrating that the user holds the game controller for operation.

### DETAILED DESCRIPTION OF PREFERRED EMBODIMENTS

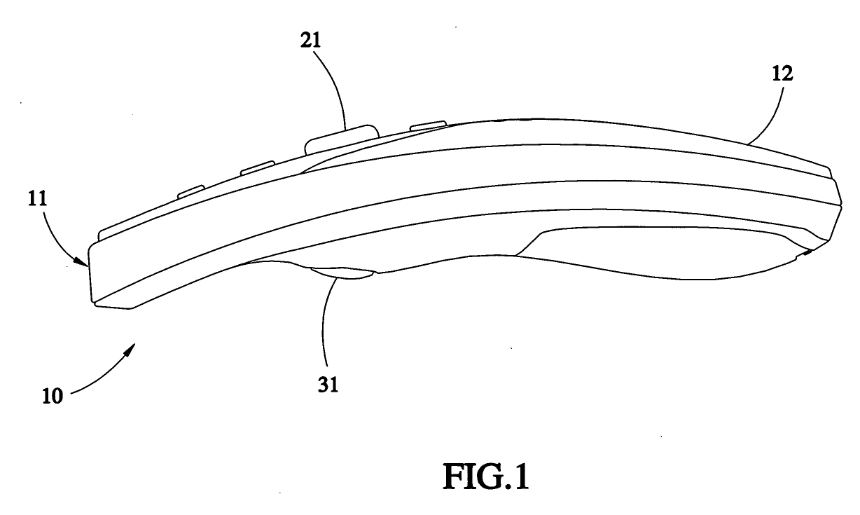

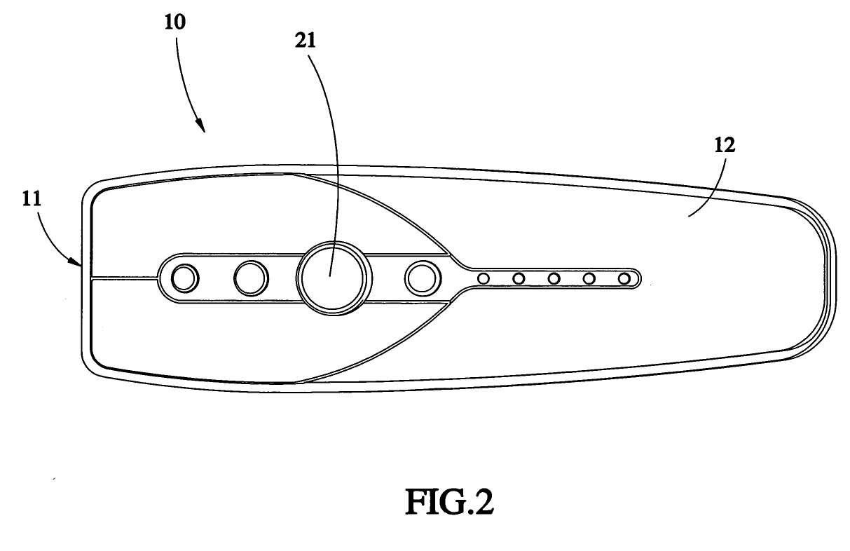

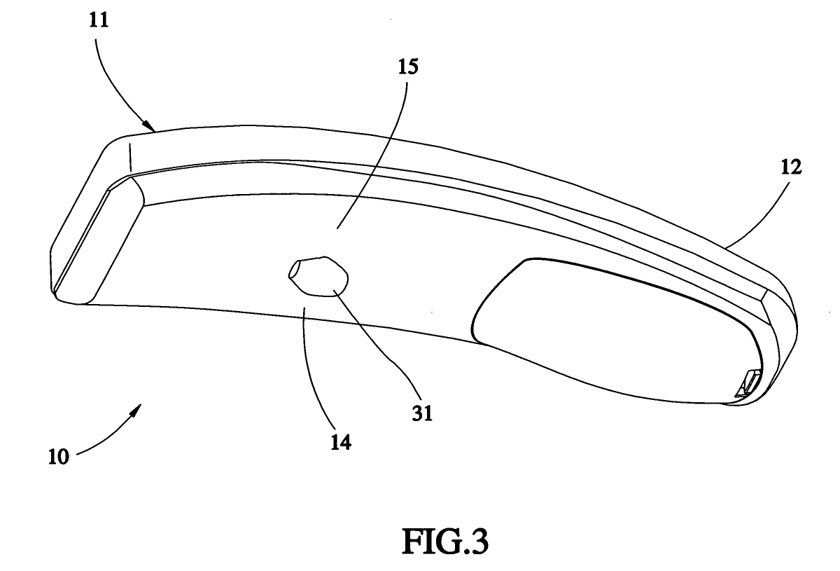

Referring to FIGS. 1-4, a 3-D wireless game controller 10 constructed based on a preferred embodiment of the present invention is comprised of a housing 11, a push control element 21, a rotation control element 31, a gravity sensor 41, a power unit 51, and a wireless communication module 61.

The housing 11 includes a grip 12 for the user's holding, having an upper surface and a lower surface.

The push control element 21 is mounted to the upper surface of the housing 1 and located corresponding to the user's thumb pad while the user holds the grip 12. In this embodiment, the push control element 21 is a D-pad, which can be pushed by the user's thumb for control of games.

The rotation control element 31 is rotatably mounted to the lower surface of the housing 11 and located corresponding to the user's forefinger pad while the user holds the grip 12. In this embodiment, the rotation control element 31 is a rotary push button, which can be not only rolled but also pushed by the user's forefinger pad.

The gravity sensor 41 is mounted to the housing 11 for detecting motions of the housing 11 and converting them into electronic signals.

The power unit 51, in this embodiment, is a battery module and mounted in the housing 11 for supplying power.

The wireless communication module 61 is electrically connected with the push control element 21, the rotation control element 31, and the gravity sensor 41, for outbound wireless transmission of electronic signals generated from the push control element 21, the rotation control element 31, and the gravity sensor 41.

The housing 11 includes a left lateral 14 and a right lateral 15, which are located on the lower surface of the housing 11 and at the left and right sides of the rotation control element 31 respectively, wherein the rotation control element 31 protrudes for a predetermined distance with respect to the left and right laterals 14 and 15 for operation of the user's forefinger. The left and right laterals 14 and 15 cooperate with the rotation control element 31 to form a camber corresponding to radian of the user's forefinger bending while the user holds the grip 12. The camber can increase the operational convenience and comfort for the user holding the grip 12.

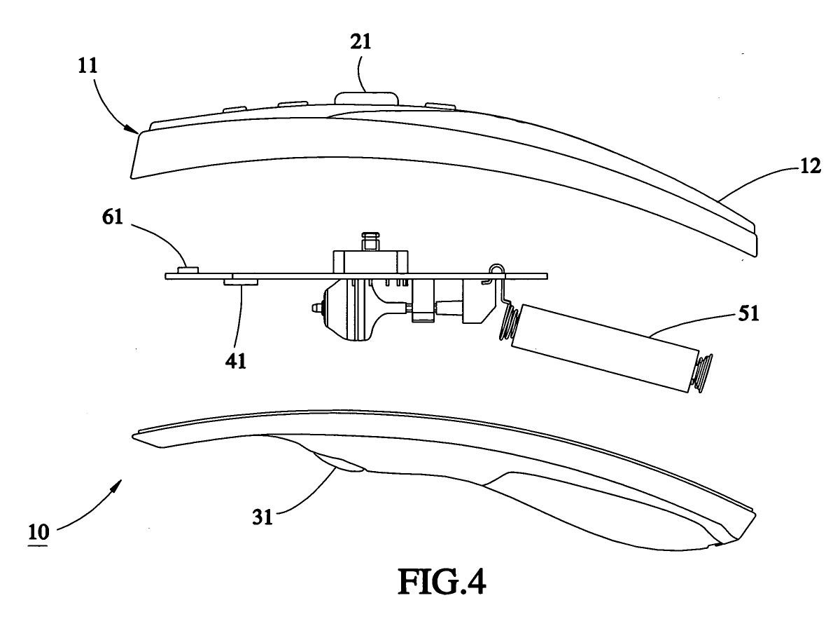

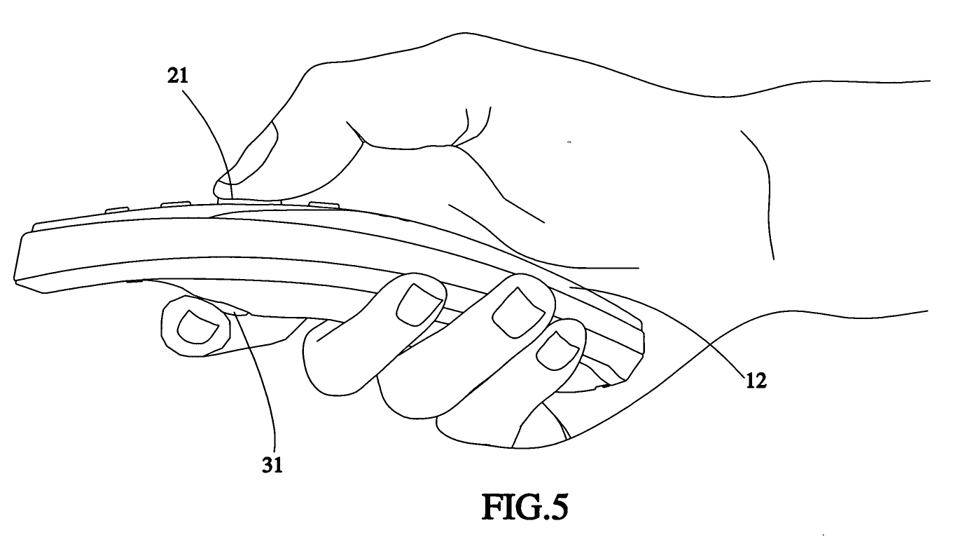

Referring to FIG. 5, before operating the present invention, the user holds the grip 12 with the thumb pad located on the push control element 21 and the forefinger pad located in the front of the rotation control element 31. While operating the 3-D wireless game controller 10 of the present invention, the user's thumb pad pushes the push control element 21, or the user's forefinger pad rolls or pushes the rotation control element 31, and then such operations are converted into electronic signals to be transmitted outward by the wireless communication module 61 shown in FIG. 4, attaining the controlling purpose.

In light of the above, the present invention includes the following advantages.

1. No space required for accommodation of user's forefinger

The game controller of the present invention does not need to provide any additional space for accommodating the user's forefinger as the aforementioned conventional gamepad (i.e. U.S. Pat. Pub. No. 2007/0066394) did but directly defines the camber formed on the lower surface of the housing for placement of the user's finger.

2. Function of rotational control done by user's forefinger

The user can roll the rotation control element by the forefinger pad to do the control of rotation and push, so the present invention provides more functions, which can be done by the user's forefinger, than the prior art did.

3. More comfortable for holding and operation

The camber defined by the left and laterals and the rotation control element, corresponding to the radian of the user's bending forefinger, enables the user to feel more comfortable while holding and operating the game controller.

Although the present invention has been described with respect to a specific preferred embodiment thereof, it is no way limited to the details of the illustrated structures but changes and modifications may be made within the scope of the appended claims.

What is claimed is:

1. A 3-D wireless game controller comprising:
a housing having a grip for a user's holding, said housing having an upper surface and a lower surface;
a push control element mounted to the upper surface of said housing and located corresponding to the user's thumb pad while the user holds said grip;
a rotation control element rotatably mounted to the lower surface of said housing and located corresponding to the user's forefinger pad while the user holds said grip;
a gravity sensor mounted to said housing for detecting motions of said housing and converting them into electronic signals;
a power unit mounted in said housing for providing power; and
a wireless communication module electrically connected with said push control element, said rotation control element, and said gravity sensor for outbound wireless transmission of electronic signals generated from said push control element, said rotation control element, and said gravity sensor.

2. The 3-D wireless game controller as defined in claim 1, wherein said rotation control element is functioned as a push button.

3. The 3-D wireless game controller as defined in claim 2, wherein said rotation control element is a rotary push button.

4. The 3-D wireless game controller as defined in claim 1, wherein said power unit is a battery module.

5. The 3-D wireless game controller as defined in claim 1, wherein said push control element is a D-pad.

6. The 3-D wireless game controller as defined in claim 1, wherein said housing further comprises a left lateral and a right lateral located on the lower surface of said housing and at the left and right sides of said rotation control element respectively, said left and right laterals cooperate with said rotation control element to form a camber corresponding to radian of the user's forefinger bending while the user holds said grip, said rotation control element protruding for a predetermined distance with respect to said left and right laterals for operation of the user's forefinger.
